(19) United States
(12) Patent Application Publication
(10) Pub. No.: US 2008/0141872 A1
(43) Pub. Date: Jun. 19, 2008

(54) Pressing Method for Sealing Heat Pipe

(76) Inventor: Jian-Dih Jeng, Linkou Township (TW)

Correspondence Address: HDSL, 4331 STEVENS BATTLE LANE, FAIRFAX, VA, 22033, US

(21) Appl. No.: 11/611,887

(22) Filed: Dec. 17, 2006

(51) Int. Cl. B30B 13/00

(52) U.S. Cl. 100/35

(57) ABSTRACT

A pressing method for sealing a heat pipe includes steps of providing a tube material or sheet material with/without an intermediate material, pressing by a pair of pressing molds, wherein a plurality of protrusions are formed on at least one of the pressing surface of the pair of the pressing molds. The protrusion pattern of the pressing surface of the pressing molds used in the present pressing method is for enhancing the sealing strength of the heat pipe.

### BACKGROUND OF THE INVENTION

1. Field of the Invention

The present invention relates to a pressing method for sealing a heat pipe. Particularly, the present method relates to a pressing method applied to a tube material or sheet material with/without an intermediate material for sealing and reinforcing a heat pipe. Pressing molds with a plurality of protrusions provided in the present pressing method are designed to enhance the sealing strength of the heat pipe.

2. Description of the Related Art

A heat pipe is made from a tube material with capillary structure. In conventional method, the open end of the material should be sealed after the formation of the capillary structure is complete. The sealing of the open ends is performed by a pressing process which utilizes an upper mold and a lower mold to press the ends to compress the open ends being deformed and thus, be bound. For increasing the sealing strength of the sealed part of the heat pipe to be pressed, more deformation of the sealed part in compression is required. However, the increased deformation of the sealed part will result in the metal crack, and will conduct the leakage defect, especially when the part is made of aluminum, copper and the like. To avoid the leakage defect, the sealed part is further welded to secure sealing strength thereof.

### SUMMARY OF THE INVENTION

The present invention is to provide an improved pressing method for providing the sealing strength of a heat pipe. The pressing method of the present invention comprises steps of providing a tube material or sheet material with/without an intermediate material, pressing the tube material or sheet material with a pair of pressing molds, wherein a plurality of protrusions are formed on at least one of the pressing surface of the pair of the pressing molds. The plurality of the protrusions of the pressing surface of the pressing molds is used in the present pressing method are for enhancing the sealing strength of the heat pipe.

The protrusion pattern of the pressing surface of the pressing molds is in a pattern comprising a plurality of protrusions in a shape of dot, bar, convex, curve or the like. The protrusion pattern is formed on one or both of a pair of the pressing molds that includes an upper mold and a lower mold. Due to the protrusions of the pressing molds, the pressing strength will be locally concentrated on the protrusions so as to cause the cold welding effect of the tube or sheet material at the contact area of the protrusions and the tube or sheet material and thus, provide more sealed binding strength.

According to another aspect of the present invention, an intermediate material is provided between the layers of the tube or sheet material. The intermediate material is a discontinuous material, such as a mesh, fibers, a porous material and the like, or a continuous material, such as a metal sheet. The intermediate metal sheet is an alloy for example. The primary metal of the alloy of the intermediate metal sheet can be the material same as that of tube or sheet material. The second metal of the alloy is a metal with a melting point lower than that of the primary metal of the alloy. For example, when a copper (Cu) heat pipe is manufactured and conducted a pressing procedure, the intermediate metal sheet is an alloy such as Cu—Ni alloy, Cu—Sn alloy, Cu—Bi alloy, Cu—In alloy or the likes. The Cu is the majority of the alloy. The metal in the alloy with a lower melting point acts as the binding agent between the upper and lower sheets.

### DESCRIPTION OF THE DRAWINGS

The invention can be more fully understood by reading the subsequent detailed description in conjunction with the examples and references made to the accompanying drawings, wherein:

FIG. 1 is a perspective view of an open end of a pressing sealed heat pipe;

FIG. 2 is a perspective view of an example of a tube or sheet material for pressing sealed procedure according to the present invention;

FIG. 3 is a perspective view of another example of a tube or sheet material for pressing sealed procedure according to the present invention;

FIG. 4 is a perspective view of another example of a tube or sheet material for pressing sealed procedure according to the present invention;

FIG. 5 is a perspective view of another example of a tube or sheet material for pressing sealed procedure according to the present invention;

FIG. 6 is a perspective view of another example of a tube or sheet material for pressing sealed procedure according to the present invention;

FIG. 7 is a perspective view of another example of a tube or sheet material for pressing sealed procedure according to the present invention;

FIG. 8 is a perspective view of another example of a tube or sheet material for pressing sealed procedure according to the present invention;

FIG. 9 is a perspective view of another example of a tube or sheet material for pressing sealed procedure according to the present invention;

FIG. 10 is a perspective view of another example of a tube or sheet material for pressing sealed procedure according to the present invention;

FIG. 11 is a perspective view of another example of a tube or sheet material for pressing sealed procedure according to the present invention;

FIG. 12 is a perspective view of another example of a tube or sheet material for pressing sealed procedure according to the present invention;

FIG. 13 is a perspective view of another example of a tube or sheet material for pressing sealed procedure according to the present invention;

FIG. 14 is a perspective view of cutting the sealed part of a heat pipe after the performance of pressing sealing method according to the present invention.

### DETAILED DESCRIPTION OF THE INVENTION

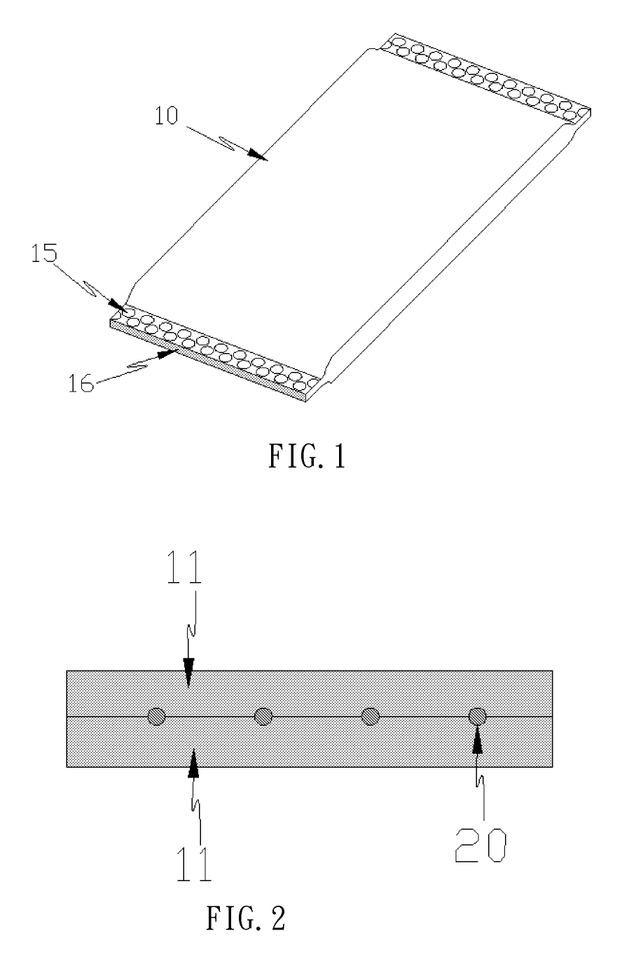

FIG. 1 is a perspective view of a heat pipe. In this example, a heat pipe 10 is manufactured by a tube material. The open ends of the tube have to be sealed by a pressing process and subsequently, a welding process is performed in order to secure the sealing strength at the end of sealed part 16. In a conventional method, a heat pipe 10 is optionally manufactured by a tube material. In this case, the pressing sealed process is conducted at all the edges of the tube material. However, the leakage defect will extensively occur as increasing the area of sealed part 16 of a heat pipe. Thus, it is desired to have a pressing method for sealing a heat pipe in order to have a reliable production thereof.

The present invention is to provide a tube or sheet material which comprises an upper layer 11, a lower layer 11 and an intermediate material 20, as shown in FIG. 2. The intermediate material is material, such as a mesh, fibers, and porous material and the like. In an example which the intermediate material 20 is a mesh, when the tube or sheet material is pressed, the intermediate material 20 will be bound between the upper and lower layers.

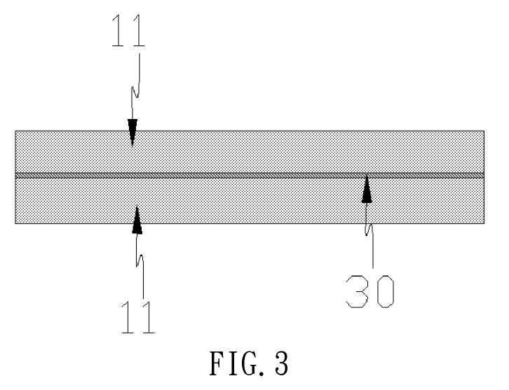

The intermediate material can also be a metal sheet, as shown in FIG. 3. The intermediate metal sheet 30 is an alloy. The primary metal of the alloy of the intermediate metal sheet 30 is the material same as the upper and lower layers 11, the second metal of the alloy is a metal with a melting point lower than that of the primary metal of the alloy. For example, when a copper (Cu) heat pipe is conducted a pressing procedure, the intermediate metal sheet is such as Cu—Ni alloy, Cu—Sn alloy, Cu—Bi alloy, Cu—In alloy or the likes. The Cu is the majority of the alloy. The metal in the alloy with a lower melting point acts as the binding agent between the upper and lower layers. The sealed part thus is, if necessary, conducted a welding procedure to reinforce the sealing strength of the sealed part.

In the above pressing procedure, a flat mold is utilized. The pressing strength of the mold is even distributed on the upper and lower layers. The upper and lower layers are compressed bound together by the discontinuous binding or by the cold welding of the intermediate material.

In another example of the present invention, the pressing mold is made with a plurality of protrusion areas which concentrate the pressing strength when the pressing procedure is conducing. The protrusion areas of the pressing mold will cause more compressing deformation on the areas of the tube or sheet material which contact with the protrusions of the molds so as to enhance the sealing strength.

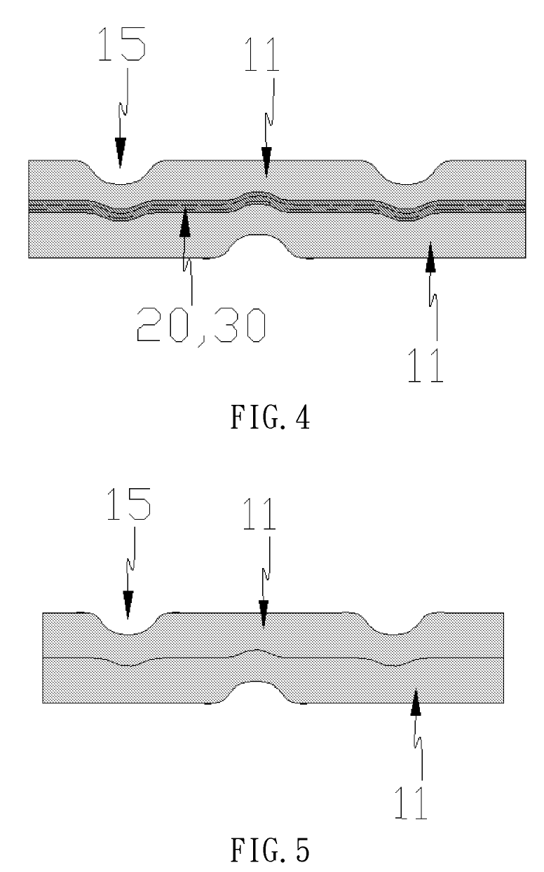

Referring to FIG. 4, a tube or sheet material which comprises an upper and a lower layer 11 and an intermediate material 20 or 30 is pressed by a pair of an upper mold and a lower mold respectively with a plurality of protrusion areas. When the pressing process is performed, the protrusion areas of the upper and lower molds contact the sheet material and cause the cold welding effect and deformation on the areas of the sheet material which contact the protrusion area in of the molds. After pressing process, plurality of indentions 15 are formed on the both sides of the sheet materials.

Either a tube material or a sheet material is performed a pressing process to seal the open ends thereof, the protrusion areas formed on the pressing surface of the upper mold and lower mold will cause a plurality of indentions 15 formed on the pressing part of the material. The pressing strength is concentrated at the protrusion areas of the molds. Due to the concentrating pressing strength, the temperature at the top of the protrusion areas is higher than that of the other area in the mold so as to cause the contact locations of the tube or sheet material which contact the protrusions areas of the molds with more compression and cold welding. Thus, the upper and lower sheets are able to be sealedly bound. Referring to FIG. 5, the similar effect of the sealing strength can be achieved by use of a pair of molds with protrusion areas on a tube or sheet material with an intermediate material.

The protrusion pattern on the pressing molds can be in various shapes, such as in a shape of dot, bar, curve, convex or the likes. The above protrusion pattern will provide the effect as requested by the present invention, such as concentrating the pressing strength to cause more compression at the contact location of the tube or sheet material, and an effective cold welding of the tube or sheet material.

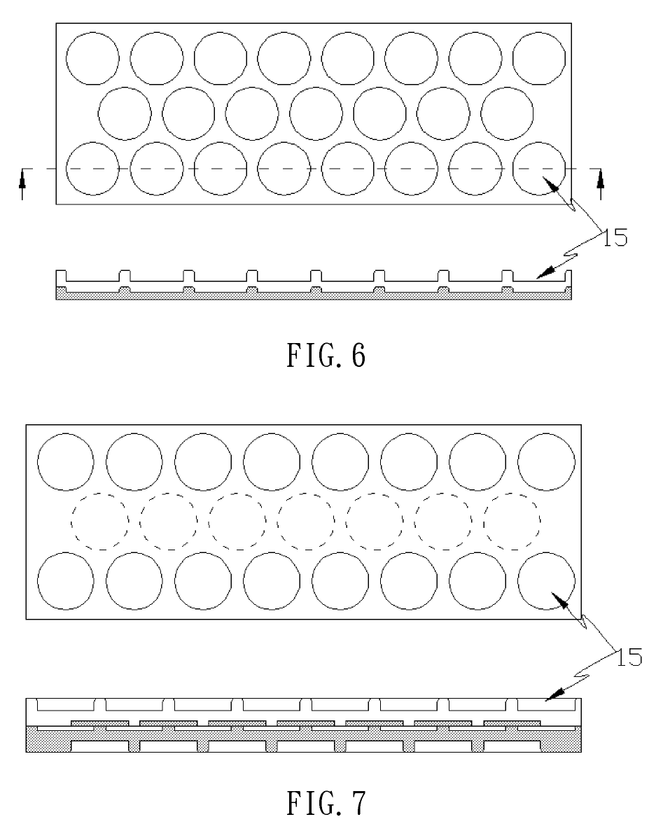

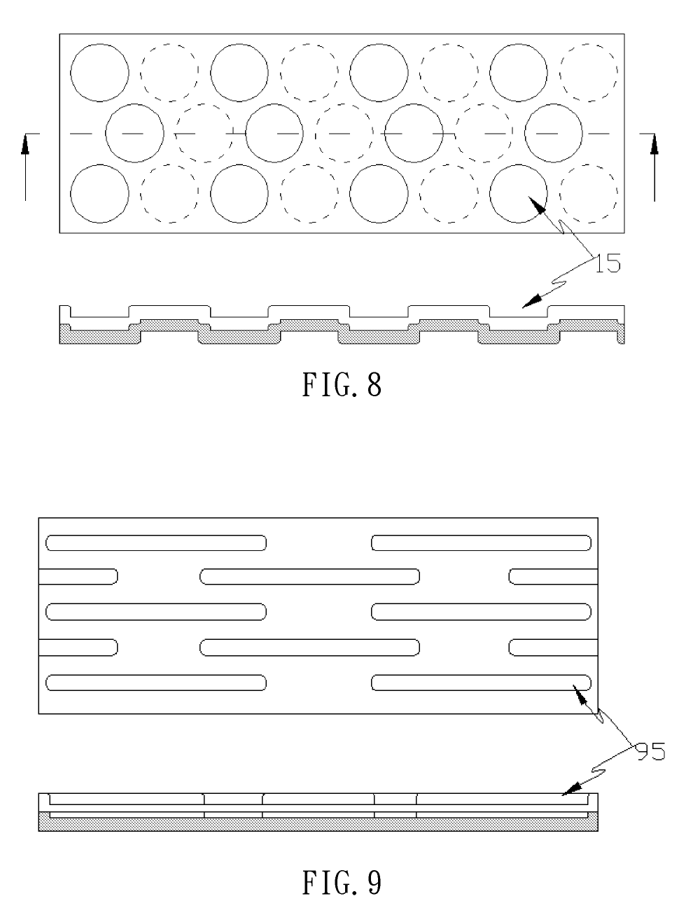

FIGS. 6, 7, and 8 show a perspective views of the sealed part of a tube or sheet material which are pressed by pressing molds with convex shape protrusion pattern. As shown in FIG. 6, one of the pair of pressing mold is in flat surface and the other one is with convex protrusion pattern, in which the convex protrusion is aligned interlacedly. Optionally, both of the upper and lower molds are able to be with convex protrusion pattern. The convex alignments on the both molds can be interlaced in horizontal lines respectively between the upper mold and lower mold. Optionally, the convex alignment can be interlaced in longitudinal lines respectively between the upper mold and lower mold, as shown in FIGS. 7 and 8. The size and the interval of the convex protrusions are determined by the composition and thickness of the sheet materials. The operation parameters of the pressing process are another one consideration for the size and the interval of the convex protrusions on the pressing molds.

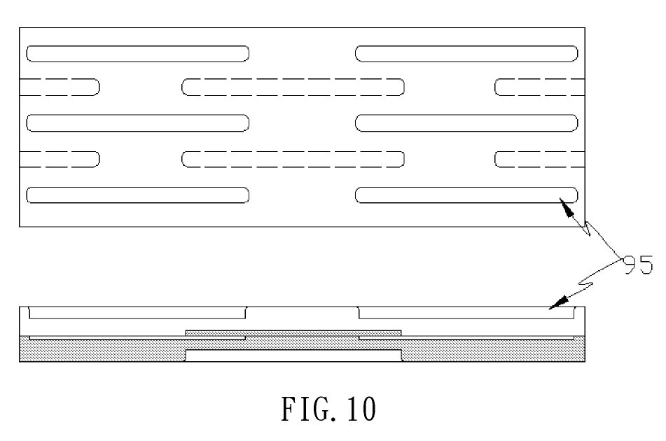

The convex protrusions on the molds can be instead by bar-shape protrusions, as shown in FIGS. 9 and 10. The molds with bar protrusions aligned or intersected interlacedly in one mold or in both of a pair of upper and lower molds are able to achieve the effects, for example, sealed binding of the tube or sheet material, desired by the present invention. The size and the interval of the convex protrusions are determined by the composition and thickness of the tube or sheet materials.

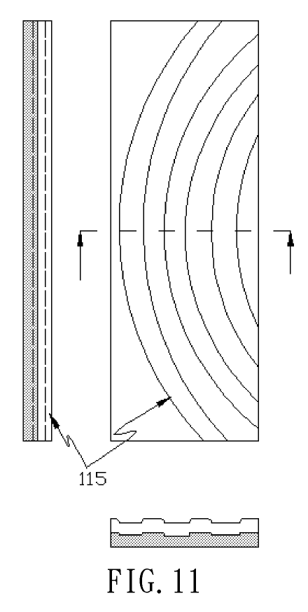

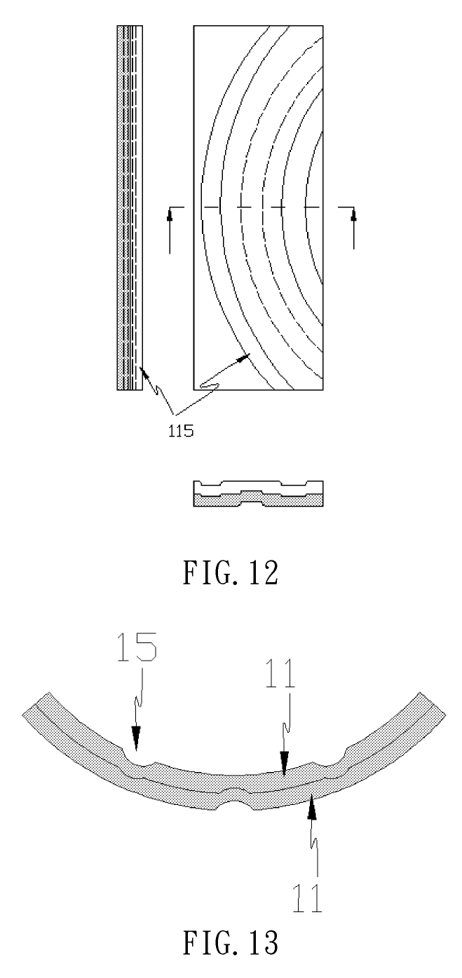

The convex protrusions on the molds can be instead by curve-shape protrusions, as shown in FIGS. 11 and 12. The molds with bar protrusions aligned interlacedly in one mold or in both of a pair of upper and lower molds are able to achieve the effects for example, sealed binding of the tube or sheet material, desired by the present invention. The size and the interval of the convex protrusions are determined by the composition and thickness of the tube or sheet materials.

The bar-shape protrusions on the molds can be instead in S-figure, W-figure or zigzag figure. Due to the protrusions on the pressing molds, the tube or sheet material is pressed to form a plurality of indentions corresponding to the protrusions of the molds. The indentions work as convexes to secure the sealed binding of the tube or sheet material. Thus, the protrusion pattern can be in various modifications without departing from the concept of the present invention.

The pressing mold can be as a curve molds as shown in FIG. 13. The sealed part is needed to be further welded, if necessary, to protect and enhance the sealed binding of the tube or sheet material.

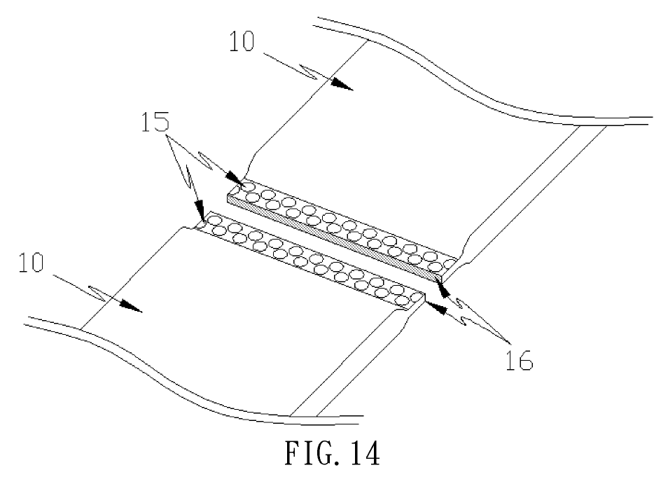

The pressing method for sealing a heat pipe disclosed in the present invention can provide a reliable sealing strength on the sealed part of a heat pipe, as shown in FIG. 14. Thus, the present method can be applied to cut and trim a workable heat pipe into several sections and simultaneously seal the cut sections. Since pressing processes then the cutting are operated at the same time, the vacuum of the heat pipe can be maintained after the cutting and trimming the pipe into several sections, such as into two heat pipes.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

What is claimed is:

1. A pressing method for sealing a heat pipe comprising steps of providing a tube material or sheet material and pressing with a pair of pressing molds, wherein a plurality of protrusions are formed on at least one of the pressing surface of the pair of the pressing molds.

2. The pressing method as claimed in claim 1, wherein the plurality of protrusions in a shape of dot.

3. The pressing method as claimed in claim 1, wherein the plurality of protrusions in a shape of bar with aligned or intersected interlacedly.

4. The pressing method as claimed in claim 1, wherein the plurality of protrusions in a shape of convex.

5. The pressing method as claimed in claim 1, wherein the plurality of protrusions in a shape of curve, S-figure, W-figure or zigzag figure.

6. The pressing method as claimed in claim 1, wherein the protrusions are interlacedly aligned on the pressing surface of the pressing molds.

7. The pressing method as claimed in claim 1, wherein the protrusions are on both pressing surfaces of the upper and lower molds.

8. The pressing method as claimed in claim 1, wherein the protrusions are on either one of the pressing surface of the upper and lower molds and the other pressing surface is even.

9. The pressing method as claimed in claim 7, wherein the protrusion alignment on the both molds is interlaced in horizontal lines or intersected lines respectively between the upper mold and lower mold.

10. The pressing method as claimed in claim 7, wherein the protrusion alignment is interlaced in longitudinal lines or intersected lines respectively between the upper mold and lower mold.

11. The pressing method as claimed in claim 1, wherein the operation parameters of the pressing process are determined by the size and the interval of the protrusions on the pressing molds.

12. The pressing method as claimed in claim 1, wherein the pressing mold is a flat mold.

13. The pressing method as claimed in claim 1, wherein the pressing mold is a curve mold.

14. The pressing method as claimed in claim 1 further comprising a step of welding the sealed part of the pressed heat pipe to secure the sealing strength.

15. The pressing method as claimed in claim 1, wherein an intermediate material is provided between the layers of a tube or sheet material.

16. The pressing method as claimed in claim 15, wherein the intermediate material is a discontinuous material selected from a group consisting of mesh, fiber, porous material and the like.

17. The pressing method as claimed in claim 15, wherein the intermediate material is an alloy metal sheet.

18. The pressing method as claimed in claim 17, wherein the primary metal of the alloy of the intermediate metal sheet is the material same as sheet material and the second metal of the alloy is a metal with a melting point lower than that of the primary metal of the alloy.

19. The pressing method as claimed in claim 18, wherein when the sheet material is copper, the intermediate metal sheet is selected from the group consisting of Cu—Ni alloy, Cu—Sn alloy, Cu—Bi alloy, Cu—In alloy and the likes.

20. The pressing method as claimed in claim 19, wherein Cu is the majority of the intermediate metal sheet.

21. The pressing method as claimed in claim 1, wherein the cutting after pressing procedure in the same time and let one heat pipe become two heat pipes and all kinds of heat pipe maintain original heat pipe performance.
